(19) United States
(12) Patent Application Publication
(10) Pub. No.: US 2025/0198810 A1
(43) Pub. Date: Jun. 19, 2025

(54) IDENTIFICATION AND CORRECTION OF ANOMALOUS SENSOR BEHAVIOR USING CALIBRATION HARMONIZATION

(71) Applicant: INTERNATIONAL BUSINESS MACHINES CORPORATION, Armonk, NY (US)

(72) Inventors: Rajesh Kumar Saxena, Thane West (IN); Harish Bharti, Pune (IN); Shilpa Shetty, Sydney (AU); Sandeep Sukhija, Rajasthan (IN)

(21) Appl. No.: 18/541,505

(22) Filed: Dec. 15, 2023

(51) Int. Cl. G01D 18/00

(52) U.S. Cl. CPC G01D 18/00

(57) ABSTRACT

Sensor calibration harmonization includes generating, over a time epoch, a time series of uncalibrated sensor measurements produced by a plurality of sensors. The time epoch is a dynamically variable span of time during which enough uncalibrated sensor measurements are collected to enable estimation of calibration gains and offsets for the plurality of sensors during the time epoch. The calibration gains and offsets are determined based on calibration harmonization of the uncalibrated sensor measurements. The calibration harmonization generates a linear transformation that determines the offsets by projecting a selected set of uncalibrated gains onto a linear subspace, and determines the calibrated gains based on the offsets. The plurality of sensors may be reconfigured in response to determining which sensors generate measurements that when calibrated based on calibration harmonization lie within an acceptable range.

### BACKGROUND

This disclosure relates to sensors and, more particularly, to identifying and calibrating certain types of measurements generated using clusters of sensors.

A sensor includes any physical device capable of generating an output signal in response to a sensed physical phenomenon. Often, a sensor is designed to generate a continuous output signal proportional to a measurable aspect of the sensed physical phenomenon. Many types of sensors implement, at least approximately, a linear transfer function such that the output signal provides a quantitative measure that is proportional to the sensed physical phenomenon. For example, a sensor may measure temperature by generating an output voltage in response to sensing a temperature, the sensitivity of the voltage response corresponding to the slope of the linear transfer function. Other physical phenomenon measured by sensors include speed, displacement, pressure, strain, and a host of other such phenomena. Many edge computing devices have attached sensors enabling them to respond to real-world events with sub-millisecond latencies. Additionally, sensors are increasingly deployed in arrays or clusters of multiple sensors for measuring various physical phenomena.

### SUMMARY

In one or more embodiments, a method includes generating, over a time epoch, a time series of uncalibrated sensor measurements produced by a cluster of sensors. The time epoch is a dynamically variable span of time during which enough uncalibrated sensor measurements are collected to enable estimation of calibration gains and offsets for the plurality of sensors during the time epoch. The method includes determining the calibration gains and offsets based on calibration harmonization of the uncalibrated sensor measurements. The calibration harmonization generates a linear transformation that determines the offsets by projecting a selected set of uncalibrated gains onto a linear subspace, and determines the calibrated gains based on the offsets. The method includes reconfiguring the cluster of sensors in response to determining which sensors generate measurements that when calibrated based on calibration harmonization lie within an acceptable range.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example architecture of a sensor calibration harmonization (SCH) framework.

FIG. 2 illustrates an example method of operation of the SCH framework of FIG. 1.

FIG. 3 illustrates some operative features of certain embodiments of SCH framework of FIG. 1.

FIGS. 4A-B illustrate other operative features of certain other embodiments of SCH framework of FIG. 1.

FIG. 5 illustrates an example of a computing environment that is capable of implementing the SCH framework of FIGS. 1 and 2.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to sensors and, more particularly, to identifying and calibrating certain types of measurements generated by clusters of sensors. In accordance with the inventive arrangements described within this disclosure, methods, systems, and computer program products are provided that are capable of detecting anomalous sensor measurements and determining whether or not such measurements are erroneous. The inventive arrangements are capable of decomposing sensor-generated readings into estimates of the true gains and offsets of a cluster of sensors. The estimates may be determined by the inventive arrangements under the burden of abnormal random noise variance. The inventive arrangements determine the estimates by a calibration harmonization of vectorial representations of sensor-generated measurements. The vectorial representation are elements of a transformed subspace of a vector space of solutions.

In certain embodiments, a time series is generated over a predetermined time epoch. The time series comprises uncalibrated sensor measurements produced by a cluster of sensors. The time epoch, in accordance with certain embodiments, is a dynamically variable span of time during which enough uncalibrated sensor measurements are collected to enable estimation of calibration gains and offsets for the plurality of sensors during the time epoch. The calibration gains and offsets are determined based on calibration harmonization of the uncalibrated sensor measurements. Calibration harmonization generates a linear transformation that determines the offsets by projecting a selected set of uncalibrated gains onto a linear subspace, and determines the calibrated gains based on the offsets. The cluster of sensors may be reconfigured in response to determining which sensors generate measurements that when calibrated based on calibration harmonization lie within an acceptable range and which sensors do not.

The embodiments provide the following technical effects. The calibration gains and offsets are expected values of the true gain and offset of each sensor. The speed and efficiency of determining the expected values is enhanced by the calibration harmonization of a time series of measurements, thus obviating the need to individually, and potentially less reliably, determine each sensor's actual gain and offset. Calibrating the sensor-generated measurements with expected values of the true gains and offsets enables identification of measurements that are in fact erroneous rather than merely anomalous. Measurements calibrated with the estimated true gains and offsets lie within an acceptable range. Erroneous measurements do not.

Among the technological improvements of the inventive arrangements over conventional technology is operation with respect to a cluster or sub-array of an array or network of sensors. Clustering select sensors within a larger network of sensors offers distinct technical advantages. One technical advantage is enhanced reliability and operational efficiency. Other technical advantages include fault tolerance and data aggregation. In accordance with the inventive arrangements, an array or network of sensors can be clustered in accordance with certain aspects of a process (e.g., a business or technological process) controlled and/or monitored by the sensors. Clustering is a logical grouping of sensors such that the sensors in a cluster are similar to one another, yet dissimilar to other sensors in the array or in other clusters, the logical grouping based on one or more attributes that the similar sensors play in controlling and/or monitoring processes or events. For example, a first cluster of sensors of a sensor network may serve to determine lighting efficiency within a designated area, while a second cluster serves to detect possibly dangerous conditions in proximity to one or more electric switches in the area. Thus, the clustering of sensors can differ based on the specific purpose of the sensors. Clustering can also be varied based on homogenization of measure of configuration attributes. For example, a cluster of sensors measuring temperature variance for detecting the likelihood of electrical arcing in a circuit breaker on a transformer may have different sensitivity than a cluster whose sensors measure temperature of a circuit breaker line switch having a lightening arrestor.

With respect to a cluster of sensors, the inventive arrangements efficiently generate estimates of the true, albeit otherwise unknown, gains and offsets of the cluster of sensors. The true gains and offsets provide more fine-grained or enhanced operative control over the sensors beyond mere dead-band approximations. A dead-band approximation is an estimation of a range of values (within the domain of a transfer function) that when input to a sensor generates zero output of the sensor. The dead-band is typically a hardwired feature of the sensor dictated by the sensor's manufacturer to control gain and offset (e.g., to prevent unwanted signal variations). The inventive arrangements, by providing finer-grained control of gains and offsets, enable calibration of the sensor at a micro level.

A technological advantage associated with the inventive arrangements' calibration is generation of sensor data that may be input to a machine learning model that learns patterns of the sensor offset and gain, which may be isolated and/or localized. The learned patterns may be used to attenuate or bound sensor signals used in controlling a cascade of sensor-initiated actions that are otherwise difficult to automate if dependent on a predetermined dead-band that varies depending on the specific sensor manufacturer. A related technological advantage is that a sensor from one manufacturer may be substituted for one from another manufacturer without the danger of different dead-band calibrations. This is because, the gains and offset calibrated by the inventive arrangements as part of a processes' downstream pre-processing allows isolation of downstream automation code apart from any hardware-based configurations of a cluster of sensors.

In certain embodiments, the cluster of sensors continues to generate uncalibrated sensor measurements over time. Thus, additional time series are generated over multiple time epochs. For each successive time epoch, successive calibration gains and offsets are determined by performing calibration harmonization during each of the multiple time epochs. The cluster of sensors can be successively reconfigured based on the calibration harmonization during each of the multiple time epochs.

The cluster of sensors thus may generate a continuous stream of measurements. The sensor measurements, although perhaps changing over time, are nonetheless handled by updating the calibration gains and offsets through multiple time epochs. This can ensure the accuracy of the estimated or expected values of the sensors' true gains and offsets. A technical effect of operating mover multiple epochs is that the accuracy of the measurements remains stable over time based on the calibration harmonization over multiple time epochs thereby providing more accurate sensor calibration.

In some embodiments, reconfiguring the cluster of sensors includes calibrating each sensor based on the calibration gains and offsets for sensors that generate measurements within the acceptable range. One technical effect is an enhancement of the accuracy of the sensors. Another technical effect is the capability to distinguish those sensors that are generating anomalous but not erroneous measurements from sensors that are in fact generating erroneous measurements.

Optionally, in some embodiments, reconfiguring the cluster of sensors may include taking offline those sensors that when calibrated based on calibration harmonization generate measurements that do not lie within the acceptable range. A technical effect of taking sensor(s) offline includes eliminating measurements that would otherwise adversely bias the estimated or expected value of the other sensors' gain and offset. Another technical effect is eliminating the allocation of processing resources to sensors generating erroneous measurements.

In some embodiments, an alert is optionally generated in response to determining that a sensor calibrated based on calibration harmonization generates measurements that do not lie within the acceptable range. A technical effect of the alert is that the alert enables system operators or engineers to respond to the situation in which a sensor is generating erroneous measurements. Because the determination can be updated during successive epochs over time irrespective of changes in the sensing environment, such alerts can serve as a rapid and timely notification to the system operators or engineers.

The time epoch, in accordance with certain embodiments, corresponds to a time interval necessary to obtain enough uncalibrated sensor measurements sufficient to enable estimation of calibration gains and offsets for the plurality of sensors. A sufficient number of measurements can be determined from the rank of a system of equations that may solved to obtain estimates of the calibration gains and offsets, the rank indicating the number of equations of the system that are independent and thus useful for solving the equations. Accordingly, the time epoch is neither arbitrarily set nor is it static. The duration of each distinct time epoch may be different. This dynamic variability of the epoch provides a technical effect of dynamically adapting to the particular sensing conditions and performance of the individual sensors over time.

Moreover, the number of uncalibrated sensor measurements is the minimum number needed to enable estimation of calibration gains and offsets. Accordingly, each time epoch in accordance with these embodiments is as short a time interval as possible to allow estimation of the true gains and offsets. Another technical effect of the dynamic variability of the epoch is, given that the estimates may be updated with each successive time epoch, is that the updates may occur frequently, limited only by the constraint that the sufficient number of measurements are obtained.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

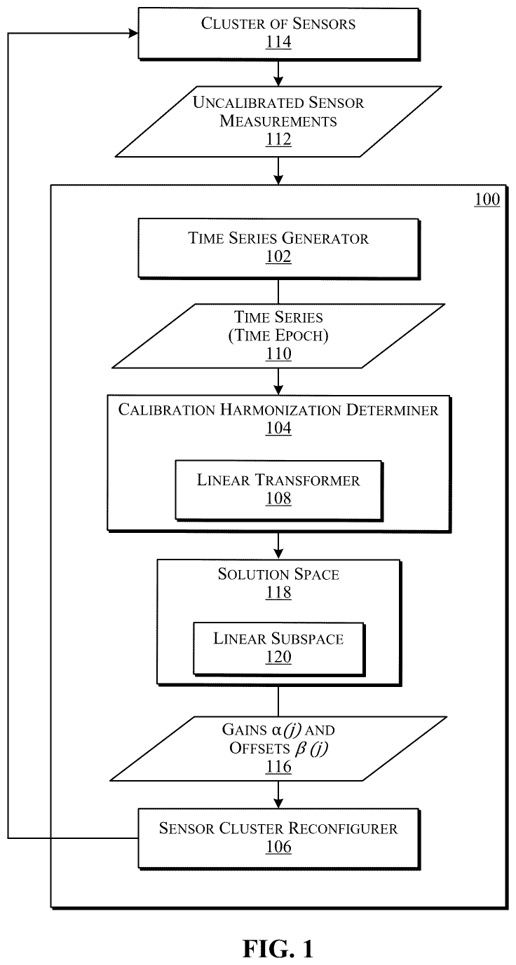

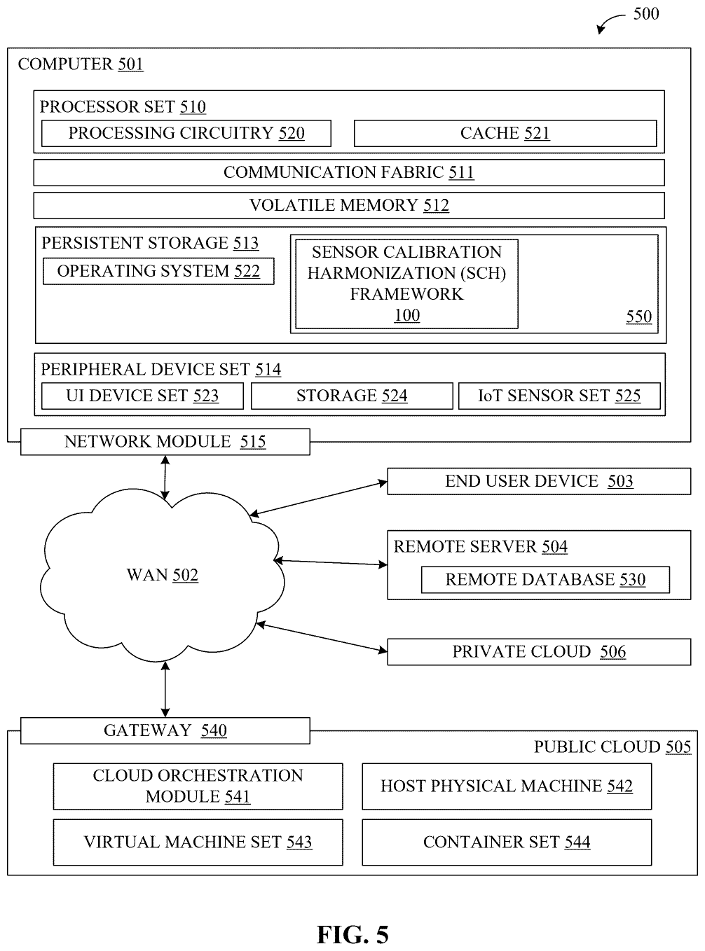

FIG. 1 illustrates an example architecture for an executable sensor calibration harmonization (SCH) framework 100. SCH framework 100 may be implemented in software that is executable on the hardware of a computer such as computer 501 operating in computing environment 500, as described in reference to FIG. 5.

In the example architecture of FIG. 1, SCH framework 100 illustratively includes time series generator 102, calibration harmonization determiner 104, and sensor cluster reconfigure 106. In certain embodiments, calibration harmonization determiner 104 implements linear transformer 108.

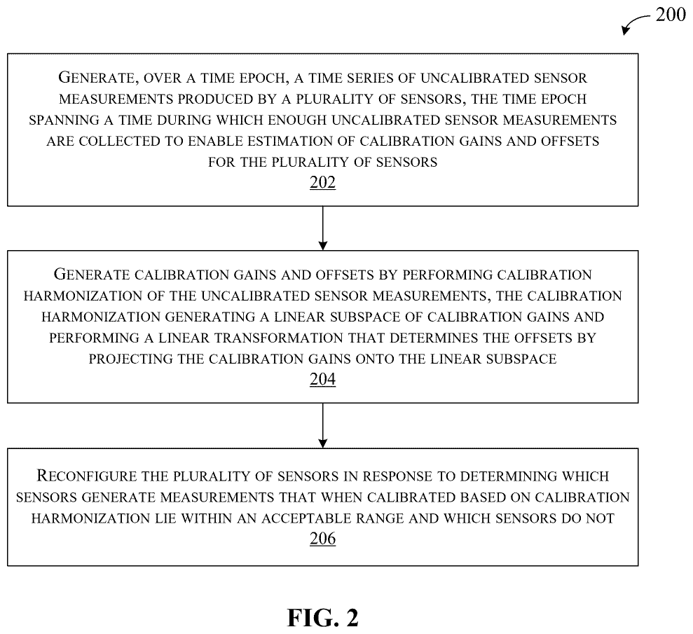

FIG. 2 illustrates an example method 200 of operation of the SCH framework 100 of FIG. 1. Referring to FIGS. 1 and 2 collectively, in block 202, time series generator 102 generates time series 110 of uncalibrated sensor measurements 112. Uncalibrated sensor measurements 112 are signals generated by cluster of sensors 114 in response to a predetermined event or physical phenomenon. Cluster of sensors 114, in various embodiments, may be a sub-array of a larger array or network of sensors. The proximity of the sensors of cluster of sensors 114 to one another is such that they provide the same and/or related measurements of the same predetermined event or physical phenomenon. Time series generator 102 generates times series 110 of uncalibrated sensor measurements over a time epoch. The time epoch is a span of time during which sensor-generated readings are processed and analyzed to ensure that enough data points are acquired to measure a sensor's calibration offset, which in turn is processed to measure the sensor's calibration gain, as described below. For example, cluster of sensors 114 may comprise sensors generating readings every five seconds, and each time epoch may be a thirty-second interval at the end of which all available readings are analyzed for the given epoch.

The duration of the time epoch is determined by time series generator 102. In certain embodiments, the time span of an epoch is a minimum time frame not less than the reporting frequency of each of the sensors in cluster of sensors 114. For example, if the highest frequency of reporting is at 10-second intervals, then time series generator 102 identifies that frequency and sets the time epoch to span not less than 10 seconds. In some embodiments, time series generator may vary the time epoch subject to the aforementioned constraint in accordance with the criticality of the specific process(es) or event(s) controlled or monitored by cluster of sensors 114. For example, if the control or monitoring of a process or event is incompatible with a lengthy time latency, then the time epoch can be adjusted downward by time series generator 102 to accommodate a shorter time latency.

In one or more embodiments, a sufficient number of measurements constituting a time epoch can be determined from the rank of a system of equations that may be solved to obtain estimates of the calibration gains and offsets. The rank indicates the number of equations of the system that are independent and thus useful for solving the equations. Given the prior example of a sensor reporting frequency (e.g., the frequency at which the sensor generates data) of 10 seconds and a rank of 10, time series generator 102 may identify that frequency and calculate the time epoch to be 100 seconds (e.g., sensor reporting frequency times rank).

In one or more other embodiments, time series generator 102 may limit the time epoch to a time interval of initiation of a system receiving data from cluster of sensors 114. As an illustrative, non-limiting example, for a thermostat that receives temperature data, but only processes batches of the data at five-minute intervals, time series generator 102 may constrain the time epoch to not more than five minutes. This ensures that the sensors of cluster of sensors 114 are calibrated at least once for each 5-minute time span.

In one or more other embodiments, the upper limit of the time span of an epoch may be established by time series generator 102 in support of a predetermined sensitivity or accuracy requirement. Given the assumption that the greater number of readings per sensor, the greater the accuracy of the estimates of the calibration gains and offsets, for example, time series generator 102 may set or extend the time epoch for greater accuracy. As an illustrative, non-limiting example, time series generator 102 may establish the time epoch based on an inverse relation between the variability or deviation (e.g., absolute or standard) of the sensor-generated measurements and the time span of the epoch. The greater the variability or deviation, the longer the time epoch. The longer epoch allows greater sampling of the sensor-generated measurements, thus allowing for smoothing of the variability or deviation in determining calibrated gains and offsets, as described below.

In certain embodiments, during the monitoring or control of a single process or event, the time span may vary from one epoch to another. For example, in monitoring with cluster of sensors 114 a process that exhibits cyclical activity, time series generator 102 may establish time epochs of shorter duration during peak activity and longer activity during other phases. Time series generator 102, for example, may vary the time span from one epoch to another if sensor measurement variability changes during a process. As an illustrative, non-limiting example, time series generator 102 may compute a variance or deviation of an initial set of measurements at the beginning of a time epoch, and in real time, extend or shorten the remaining time of the epoch in response to the computed variance or deviation. The greater the computed variance or deviation the longer the time span of the epoch set by time series generator 102. The longer the time span, as already noted, the more data available to smooth out the variability and enhance the accuracy of the estimated gains and offsets.

In block 204, based on time series 110 generated over the time epoch, calibration harmonization determiner 104 determines calibration gains and offsets 116. Calibration gains and offsets 116 are estimated or mathematically expected values of the true gains and offsets of each of the n sensors of cluster of sensors 114. Calibration harmonization determiner 104 generates a linear transformer 108 that determines the offsets by projecting a selected set of uncalibrated gains onto a linear subspace of estimated calibrated sensor measurements. Based on the determined offsets, calibration harmonization determiner 104 determines estimates of the true calibrated gains.

In certain embodiments, calibration harmonization determiner 104 generates for each of a series of time epochs a composite value. The composite value of the i-th epoch c̅(i), i=1, . . . , m, is a snapshot of the values y(j), j=1, . . . , n, (reported values) generated by the n sensors of cluster of sensors 114. For n sensors, the composite value of the i-th epoch c (i) can be represented as an n-component column vector, the transpose of which is:

$$\overline{c} ( i ) = {[ y ( 1 ) , … , y ( n ) ]}^{T} . \qquad EQ . ( 1 )$$

Each sensor has an unknown gain and offset associated with its response to an event or phenomenon. Thus, instead of calibrated measurements, c(j), j=1, . . . , n, each of the n sensors of cluster of sensors 114 reports the following response to the event or phenomenon:

$$y ( j ) = {[ \frac{c ( j ) - β ( j )}{α ( j )} \vert \begin{matrix}\overline{α} = {[ α ( 1 ) . . α ( n ) ]}^{T} \\ \overline{β} = {[ β ( 1 ) . . β ( n ) ]}^{T}\end{matrix} ]}_{j = 1 . . n} \qquad EQ . ( 2 )$$

where the α(j) is a gain and the β(j) is an offset. The gain α(j) and the offset β(j) are true but unknown values, however. Calibration harmonization determiner 104 generates calibration gains and offsets by performing calibration harmonization of the uncalibrated sensor measurements. The uncalibrated sensors measurements of the j-th sensor are calibrated during the current epoch based on the calibration gain and offset, respectively, of the j-th sensor are α(j) and β(j) Based on the values of the calibration gain and offset, calibration harmonization determiner 104 generates calibrated values c(j) for each of the of the n sensors of cluster of sensors 114,

$$c ( j ) = α ( j ) y ( j ) + β ( j ) . \qquad EQ . ( 3 )$$

The true gains and offsets of each sensor j∈{1, . . . , n} of cluster of sensors 114 must satisfy EQ. (3).

Calibration harmonization determiner 104, in performing calibration harmonization, generates data structures in which uncalibrated gains of the sensor-generated measurements are identifiable as points within a vector space. Calibration harmonization determiner 104 determines solution space 118, which is a subspace of the vector space. The selected set of uncalibrated gains are those lying within solution space 118.

Linear transformer 108 recovers estimated true offsets β(j) as orthogonal complements of a linear subspace using projection matrix, P:

$$\{ P β = - P \overline{Y} \hat{α} \vert \overline{Y} = \frac{1}{k} {\sum }_{i = 1}^{k} {Y}_{i} \} . \qquad EQ . ( 4 )$$

where Y̅ is a time average of sensor-generated readings, \hat{α} is an empirically estimated gain based on gains from one or more prior time epochs, and Y is an n-by-n diagonal matrix:

$$[ \begin{matrix}y ( 1 ) & … & 0 \\ ⋮ & ⋱ & ⋮ \\ 0 & … & y ( n )\end{matrix} ] . \qquad MA . ( 1 )$$

Y̅\hat{α} is linear subspace 120 within solution space 118. The \hat{α} (based on gains from one or more prior time epochs) is used to determine the current epoch's offsets β(j), from which the current epoch's true gains α(j) are determined. The \hat{α} is calculated as the average of true calibrated gains determined during the one or more prior time epochs. Calibration harmonization determiner 104 determines current true gains from uncalibrated gains (actual values) comprising a subset of values forming solution space 118. By comparing remaining uncalibrated values to values of solution space 118, current calibrated gains are determined. In certain embodiments, the determining is based on projections onto linear subspace 120, which yields a set of vectors representing estimated or expected true values of offsets β(j). Based on the properties of a projection matrix, the projected vectors are orthogonal to the vectors Y̅\hat{α}. Thus, the offsets β(j) represented by the orthogonal vectors are the closest or “best fit” for offsets relative to linear subspace 120.

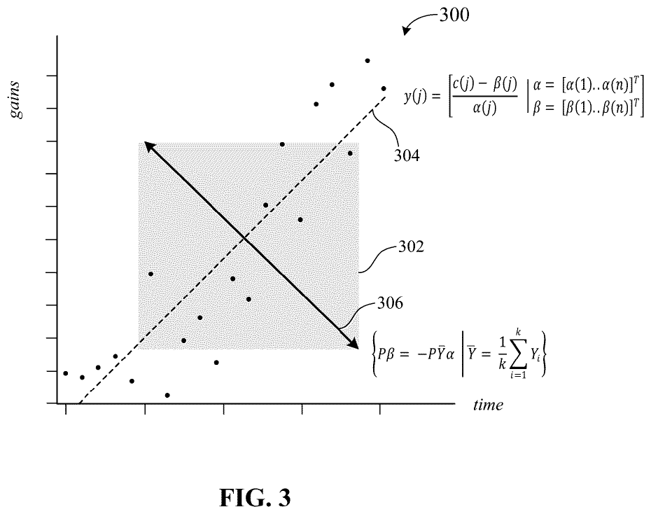

Referring additionally to FIG. 3, these operative aspects of calibration harmonization determiner 104, in accordance with certain embodiments, are schematically illustrated with graph 300. The horizontal axis of graph 300 measures time, and the vertical axis measures uncalibrated gains of a single, representative sensor of cluster of sensors 114. Shaded rectangle 302 of graph 300 schematically represents a portion of solution space 118 as a two-dimensional graph in which nine points or vectorial representations of uncalibrated gains of the j-th sensor lie. Line 304 is a graph of y(j), one of the y's of the above-described n-by-n diagonal matrix and thus lies within linear subspace 120 lying within solution space 118. The left and right boundaries of shaded rectangle 302 representing a portion of solution space 118 are determined by, and correspond to, a single time epoch. Points lying to the left and right of shaded rectangle 302 are not included within the time epoch. The line extending from the lower righthand corner of shaded rectangle 302 to the upper lefthand corner is orthogonal complement 306. Orthogonal complement 306 is generated by projection matrix P of EQ. (4), above.

The span of orthogonal complement 306 generated by projection matrix P determines the lower and upper boundaries of shaded rectangle 302 representing a portion of solution space 118. The lower and upper edges, respectively, of shaded rectangle 302 are the minimum gain and maximum values of non-anomalous uncalibrated gains lying within solution space 118. Points (uncalibrated gains) lying above and below the upper and lower boundaries of shaded rectangle 302, respectively, are out of the range determined by orthogonal complement 306 and are thus determined to be anomalous sensor-generated measurements and are ignored or discarded. Non-anomalous measurements generated by cluster of sensors 114 comprise an acceptable range of sensor-generated measurements.

Theoretically, there are no bounds on orthogonal complement 306, however, in the present context the span of orthogonal complement 306 is limited by the boundaries of the time epoch. Only the points lying within shaded rectangle 302 comprising part of solution space 118 are used to determine reliable estimates of the true offsets β(j) of measurements corresponding to the given time epoch. Reliable estimates of the true offsets β(j) are obtained from orthogonal complement 306 generated by projection matrix P. Orthogonal complement 306 is an orthogonal projection onto linear subspace 120 and is thus perpendicular to line 304 comprising a portion of linear subspace 120. Given the orthogonality of orthogonal complement 306 with respect to linear subspace 120, the slope of orthogonal complement 306 varies with the slope of line 304 lying within linear subspace 120. Thus, the slope of line 304 within linear subspace 120 determines the upper and lower bounds (the maximum gain and minimum gain, respectively) of non-anomalous measurements used by calibration harmonization determiner 104 to determine current true gains from uncalibrated gains (actual values). Specifically, the less steep the slope of line 304, the steeper the slope of orthogonal complement 306 and thus the greater the span between the minimum and maximum uncalibrated gains that are non-anomalous. Conversely, the steeper the slope of line 304, the less steep orthogonal complement 306 and thus the narrower the span between the minimum and maximum uncalibrated gains that are non-anomalous. The orthogonality condition thus enables determination of the maximum and minimum values of non-anomalous uncalibrated gains to be determined from the slope of line 304 lying within linear subspace 120.

In one or more other embodiments, the maxima and minima values of non-anomalous uncalibrated gains (represented, respectively, by upper and lower boundaries of 302) may be predetermined in accordance with the process or event monitored or controlled by cluster of sensors 114. For example, cluster of sensors 114 may be calibrated using only uncalibrated gains lying within a relatively narrow band of measurements, thus limiting the variance between the minima and maxima. As an illustrative, non-limiting example, if cluster of sensors 114 are deployed to detect electromagnetic pulses from a system or device interconnected with a main power panel, the range of measurements deemed non-anomalous may be narrowly prescribed to enhance the likelihood of detecting even slight electrical arcing. In one or more other embodiments, the maxima and minima may be predetermined in accordance with one or more properties or attributes of the sensors themselves. For example, the maxima and minima of uncalibrated gains used by calibration harmonization determiner 104 to calibrate sensor-generated measurements may be set in accordance with one or more manufacturer specifications. As an illustrative, non-limiting example, if the sensors' manufacturer specifies that sensors generate plus-or-minus a specified percentage of a median value, then the maxima and minima measurements deemed non-anomalous by calibration harmonization determiner 104 for calibrating the sensor measurements are limited to values falling within the manufacturer-specified range.

Estimates of the true offsets β(j) may be obtained from the magnitudes of distances parallel to orthogonal complement 306 and extending from the uncalibrated gains to line 304 comprising an element of linear subspace 120 lying within solution space 118.

Estimates of the true gains α(j) are determined from the estimates of the true offsets β(j). In certain embodiments, k equations that include estimates of the true offsets β(j) can be represented in vector notation as above:

$$c = Y \overline{α} + \overline{β} , \qquad EQ . ( 5 )$$

where β̅ is a k-by-1 column vector of the estimated true offsets. Subtracting the vector β̅ from both sides of the equation and pre-multiplying each side of the equation by the inverse matrix Y⁻ provides a solution for the estimates of the true gains α(j):

$$\overline{α} = {Y}^{-} ( c - \overline{β} ) . \qquad EQ . ( 6 )$$

Referring still to FIGS. 1 and 2, sensor cluster reconfigurer 106 reconfigures cluster of sensors 114 in response to determining which sensors generate measurements that when calibrated based on calibration harmonization lie within the acceptable range determined by the span of orthogonal complement 120 and which sensors do not.

Accordingly, in certain embodiments, the acceptable range once determined comprises a predetermined range that SCH framework 100 may use to determine which, if any, sensors within cluster of sensors 114 generate erroneous measurements. Erroneous measurements are ones outside a predetermined range corresponding to the specific event or process monitored or controlled with cluster of sensors 114. Having identified a sensor as generating erroneous measurements, SCH framework 100 may automatically deactivate or generate a signal designating the identified sensor as an erroneous sensor for removal from cluster of sensors 114.

In certain embodiments, sensor cluster reconfigurer 106 reconfigures cluster of sensors 114 by calibrating within-range sensors based on the calibration gains and offsets of the within-in range sensors, that is, each of the sensors that generates measurements within the acceptable range determined by orthogonal complement 120. Specifically, in some embodiments, each of the sensors within the acceptable range may be re-calibrated by applying the estimated true gain and true offset.

In other embodiments, sensor cluster reconfigurer 106 reconfigures cluster of sensors 114 by taking offline those sensors that when calibrated based on calibration harmonization generate measurements that do not lie within the acceptable range determined by orthogonal complement 120.

In still other embodiments, SCH framework 100 optionally generates an alert in response to determining that a sensor calibrated based on calibration harmonization generates measurements that do not lie within the acceptable range determined by orthogonal complement 120.

In some embodiments, SCH framework 100 operatively reconfigures the n sensors of cluster of sensors 114 by adjusting or correcting the sensors' generation of a continuous flow of measurement values. The sensors are reconfigured or fine-tuned by SCH framework 100's adjusting or correcting the measurement values as part of a pre-processing step. The pre-processing estimates and then extracts the true calibration gains and offsets of the sensors. The reconfiguring may be performed on an epoch-by-epoch basis, determining for each time epoch or frame which sensors are to be used for correct estimation and thereby indicating which sensors are anomalous sources and are to be dropped from consideration.

In some embodiments, SCH framework 100 operatively reconfigures the n sensors of cluster of sensors 114 when the cluster comprises a collection of new sensors. In ramping up the sensors, it is expected that the sensors generate measurement values comparable to ones generated by identical or similar sensors previously deployed in the same or a similar environment. SCH framework 100 reconfigures cluster of sensors 114 by calibrating ones generating non-anomalous values and dropping sensors that generate anomalous values.

In certain embodiments, true calibration gains α(j) and offsets β(j) are generated over a succession of time epochs by SCH framework 100 and are fed into a machine learning model to train the model to predict calibrated sensor measures c(j) based on inputs of uncalibrated, sensor-generated measures y(j). The machine learning model, for example, may be a deep learning neural network. The deep learning neural network may be trained to implement a regression model that generates values c(j) based on inputs of uncalibrated, sensor-generated measures y(j). In other embodiments, other machine learning models can be trained to predict calibrated sensor measures c(j) based on inputs of uncalibrated, sensor-generated measures y(j).

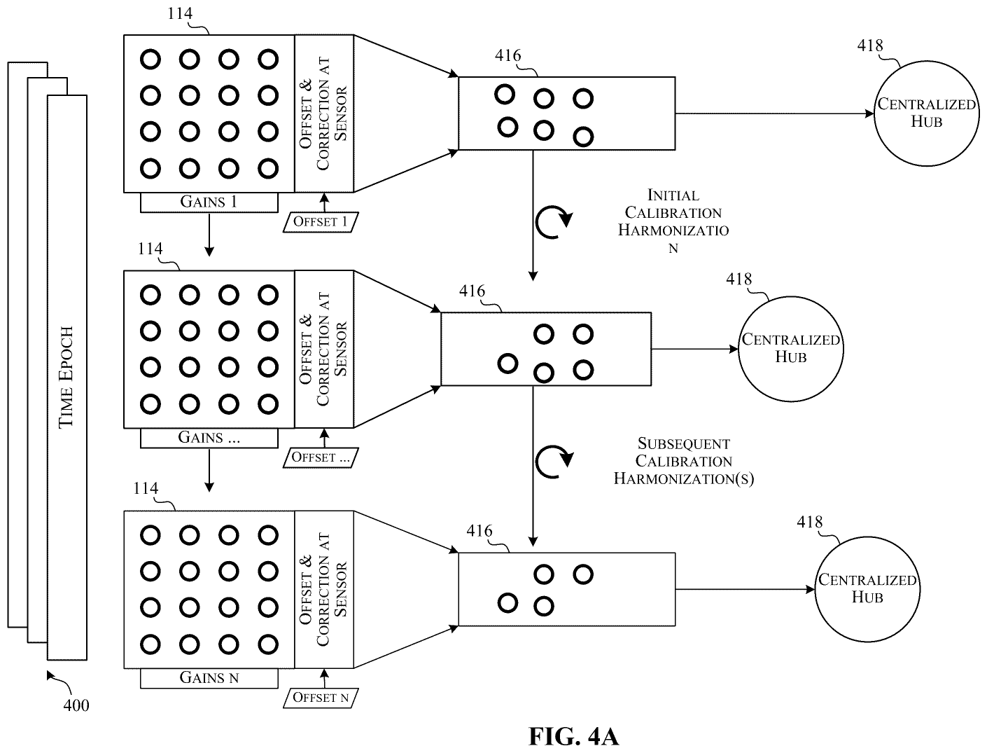

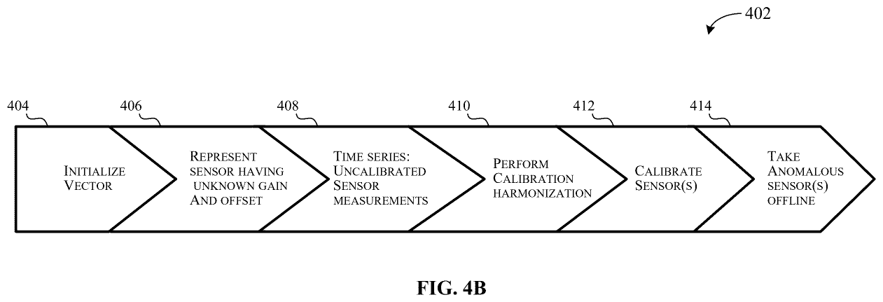

Referring now to FIGS. 4A and 4B, certain operative aspects of SCH framework 100, in certain embodiments, are illustrated with respect to a succession of time epochs 400. Operations 402 are performed with respect to each of the succession of time epochs 400. In block 404, an n-component vector is initialized for representing a snapshot of measurements generated by cluster of sensors 114. In block 406, a vectorial representation of measurements of each sensor is generated. In block 408, time series generator 102 generates a time series of uncalibrated sensor measurements. Calibration harmonization determiner 104 performs calibration harmonization in block 410, calibrating the sensors in block 412. In block 414, any sensor that is not brought within the acceptance range based on calibration harmonization is taken offline. Illustratively, an initial calibration harmonization identifies six sensors of set 416, one of which is either retained within cluster of sensors 114, based on calibration harmonization, or otherwise is taken offline. A subsequent calibration, in a next epoch, reduces by one the remaining five sensors of set 416 by either returning one to the cluster of sensors 114 or taking the sensor offline. Operations 402 may repeat with each succeeding time epoch.

Even if the time span of each of a succession of epochs is constant (though this not a requirement), the number of sensor-generated measures used to recover estimates of gains α(j) and offsets β(j) in each time epoch may vary. In certain embodiments, SCH framework 100 determines the number of sensor-generated measures k in each time epoch to ensure recovery of estimates of gains α(j) and offsets β(j) based on the following considerations, including the constraint:

$$k < \frac{n - 1}{n - r} \{ [ \begin{matrix}{PY}_{1} \\ ∶ \\ {PY}_{k}\end{matrix} ] \hat{α} = 0 \qquad EQ . ( 6 )$$

where \hat{α} is the gain estimated from one or more prior epochs, n is the total number of sensor-generated measures, and r is the number of sensor-generated measures not used. Each subsystem of equations PYⱼ has rank less than or equal to n−1 given that the projection matrix P has rank n−r. This implies that k is the minimum number of measures needed to recover the gains α(j) and offsets β(j). If

$$k > \frac{n - 1}{n - r} \qquad EQ . ( 7 )$$

then there is a differential error between the actual and estimated gain

$$e r {r}_{α} = \frac{‖ α - \overline{α} ‖}{n} \qquad EQ . ( 8 )$$

where err_{α} is the average error over the n sensors.

Referring still to FIGS. 4A and 4B, SCH framework 100 optionally may communicatively couple to centralized hub 418 that controls or monitors one or more clusters of sensors. Sensor cluster reconfigurer 106 of SCH framework 100, in some embodiments, may convey an alert to centralized hub 418 in response to identifying an out-of-range or anomalous sensor. In some embodiments, sensor cluster reconfigurer 106 may convey an instruction to centralized hub 418 instructing centralized hub 418 to take an anomalous sensor offline.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 5, computing environment 500 contains an example of an environment for the execution of at least some of the computer code in block 550 involved in performing the inventive methods, such as SCH framework 100 implemented as executable program code or instructions. SCH framework 100 detects anomalous sensor measurements and determines whether or not such measurements are erroneous. SCH framework 100 is capable of decomposing sensor-generated readings into estimates of the true gains and offsets of a cluster of sensors. The estimates may be determined by the inventive arrangements the burden of abnormal random noise variance by a calibration harmonization of vectorial representations of sensor-generated of a transformed subspace of a vector space of solutions.

Computing environment 500 additionally includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and SCH framework 100, as identified above), peripheral device set 514 (including user interface (UI) device set 523, storage 524, and Internet of Things (IoT) sensor set 525), and network module 515. Remote server 504 includes remote database 530. Public cloud 505 includes gateway 506, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

Communication fabric 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in block 550 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (e.g., where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (e.g., embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 503 is any computer system that is used and controlled by an end user (e.g., a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The terminology used herein is for the purpose of describing particular embodiments only and is not intended to be limiting. Notwithstanding, several definitions that apply throughout this document now will be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first,” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating, over a time epoch, a time series of uncalibrated sensor measurements produced by a plurality of sensors, wherein the time epoch is a dynamically variable span of time during which enough uncalibrated sensor measurements are collected to enable estimation of calibration gains and offsets for the plurality of sensors during the time epoch;
generating calibration gains and offsets by performing calibration harmonization of the uncalibrated sensor measurements, wherein the calibration harmonization generates a linear transformation that determines the offsets by projecting a selected set of uncalibrated gains onto a linear subspace, and determines the calibrated gains based on the offsets; and
reconfiguring the plurality of sensors in response to determining which sensors generate measurements that when calibrated based on calibration harmonization lie within a predetermined range.

2. The computer-implemented method of claim 1, wherein the plurality of sensors continues to generate uncalibrated sensor measurements over time, and further comprising:
generating additional time series over multiple time epochs;
successively determining for each time epoch calibration gains and offsets by performing calibration harmonization during each of the multiple time epochs; and
successively reconfiguring the plurality of sensors based on the calibration harmonization during each of the multiple time epochs.

3. The computer-implemented method of claim 1, wherein reconfiguring the plurality of sensors includes calibrating based on the calibration gains and offsets sensors that generate measurements within the predetermined range.

4. The computer-implemented method of claim 1, wherein reconfiguring the plurality of sensors includes taking offline sensors that when calibrated based on calibration harmonization generate measurements that do not lie within the predetermined range.

5. The computer-implemented method of claim 1, further comprising:
generating an alert in response to determining that a sensor calibrated based on calibration harmonization generates measurements that do not lie within the predetermined range.

6. The computer-implemented method of claim 1, wherein the predetermined range is determined by a span of an orthogonal complement generated by the linear transformation.

7. The computer-implemented method of claim 1, wherein a number of the uncalibrated sensor measurements is a minimum number sufficient to enable estimation of calibration gains and offsets.

8. A system, comprising:
one or more processors configured to initiate operations including:
generating, over a time epoch, a time series of uncalibrated sensor measurements produced by a plurality of sensors, wherein the time epoch is a dynamically variable span of time during which enough uncalibrated sensor measurements are collected to enable estimation of calibration gains and offsets for the plurality of sensors during the time epoch;
generating calibration gains and offsets by performing calibration harmonization of the uncalibrated sensor measurements, wherein the calibration harmonization generates a linear transformation that determines the offsets by projecting a selected set of uncalibrated gains onto a linear subspace, and determines the calibrated gains based on the offsets; and
reconfiguring the plurality of sensors in response to determining which sensors generate measurements that when calibrated based on calibration harmonization lie within a predetermined range.

9. The system of claim 8, wherein the plurality of sensors continues to generate uncalibrated sensor measurements over time, and wherein the one or more processors are configured to initiate operations further including:
generating additional time series over multiple time epochs;
successively determining for each time epoch calibration gains and offsets by performing calibration harmonization during each of the multiple time epochs; and
successively reconfiguring the plurality of sensors based on the calibration harmonization during each of the multiple time epochs.

10. The system of claim 8, wherein reconfiguring the plurality of sensors includes calibrating based on the calibration gains and offsets sensors that generate measurements within the predetermined range.

11. The system of claim 8, wherein reconfiguring the plurality of sensors includes taking offline sensors that when calibrated based on calibration harmonization generate measurements that do not lie within the predetermined range.

12. The system of claim 8, wherein the one or more processors are configured to initiate operations further including:
generating an alert in response to determining that a sensor calibrated based on calibration harmonization generates measurements that do not lie within the predetermined range.

13. The system of claim 8, wherein the predetermined range is determined by a span of an orthogonal complement generated by the linear transformation.

14. A computer program product, the computer program product comprising:
one or more computer-readable storage media and program instructions collectively stored on the one or more computer-readable storage media, the program instructions executable by a processor to cause the processor to initiate operations including:
generating, over a time epoch, a time series of uncalibrated sensor measurements produced by a plurality of sensors, wherein the time epoch is a dynamically variable span of time during which enough uncalibrated sensor measurements are collected to enable estimation of calibration gains and offsets for the plurality of sensors during the time epoch;
generating calibration gains and offsets by performing calibration harmonization of the uncalibrated sensor measurements, wherein the calibration harmonization generates a linear transformation that determines the offsets by projecting a selected set of uncalibrated gains onto a linear subspace, and determines the calibrated gains based on the offsets; and
reconfiguring the plurality of sensors in response to determining which sensors generate measurements that when calibrated based on calibration harmonization lie within a predetermined range.

15. The computer program product of claim 14, wherein the plurality of sensors continues to generate uncalibrated sensor measurements over time, and wherein the program instructions are executable by the processor to cause the processor to initiate operations further including:
generating additional time series over multiple time epochs;
successively determining for each time epoch calibration gains and offsets by performing calibration harmonization during each of the multiple time epochs; and
successively reconfiguring the plurality of sensors based on the calibration harmonization during each of the multiple time epochs.

16. The computer program product of claim 14, wherein reconfiguring the plurality of sensors includes calibrating based on the calibration gains and offsets sensors that generate measurements within the predetermined range.

17. The computer program product of claim 14, wherein reconfiguring the plurality of sensors includes taking offline sensors that when calibrated based on calibration harmonization generate measurements that do not lie within the predetermined range.

18. The computer program product of claim 14, wherein the program instructions are executable by the processor to cause the processor to initiate operations further including:
generating an alert in response to determining that a sensor calibrated based on calibration harmonization generates measurements that do not lie within the predetermined range.

19. The computer program product of claim 14, wherein the predetermined range is determined by a span of an orthogonal complement generated by the linear transformation.

20. The computer program product of claim 19, wherein a number of the uncalibrated sensor measurements is a minimum number sufficient to enable estimation of calibration gains and offsets.
